(19) United States
(12) Patent Application Publication
(10) Pub. No.: US 2015/0289042 A1
(43) Pub. Date: Oct. 8, 2015

(54) ELECTRONIC DEVICE AND ASSEMBLY METHOD OF ELECTRONIC DEVICE

(71) Applicant: FUJITSU LIMITED, Kawasaki-shi (JP)

(72) Inventors: Atsushi Yamaguchi, Kawasaki (JP); Shingo Yamaguchi, Kawasaki (JP)

(21) Appl. No.: 14/636,343

(22) Filed: Mar. 3, 2015

(30) Foreign Application Priority Data
Apr. 4, 2014 (JP) 2014-077993

(51) Int. Cl. H04R 1/02; H04R 31/00

(52) U.S. Cl. CPC H04R 1/025; H04R 31/00; H04R 1/021

(57) ABSTRACT

An electronic device includes: a component accommodated within a housing; a first fitting portion protruding from an inner surface of the housing toward the component; and a second fitting portion fitted to the first fitting portion, the second fitting portion including a second abutting surface abutted on a first abutting surface of the first fitting portion, wherein the component is sealed in a component chamber by a sealing member constituted by the first fitting portion and the second fitting portion, and a groove or a lateral hole is formed in the first abutting surface or the second abutting surface.

### CROSS-REFERENCE TO RELATED APPLICATIONS

This application is based upon and claims the benefit of priority of the prior Japanese Patent Application No. 2014-077993 filed on Apr. 4, 2014, the entire contents of which are incorporated herein by reference.

### FIELD

The embodiments discussed herein are related to an electronic device and an assembly method of the electronic device.

### BACKGROUND

An acoustic component such as a microphone or a speaker, which is a non-water resistant electronic component, may be mounted on an electronic device such as a mobile phone or a tablet computer. When an acoustic component is assembled with a housing, a compressible member such as rubber or foamed urethane may be interposed between the acoustic component or a substrate mounted with the acoustic component and the housing so that the electronic device is assembled by pressurizing the compressible member.

When an electronic device is assembled as described above, an acoustic component chamber including the acoustic component may be isolated from another space within the housing, and its airtightness may be improved. As a result, sound is suppressed from leaking from the acoustic component chamber, or noise is suppressed from intruding from another space within the housing into the space of the acoustic component chamber, thereby improving the sensitivity of the acoustic component.

A waterproof cover may cover a sound hole formed in the housing so as to suppress the acoustic component within the housing from being broken through repetitive submergences of the electronic device. However, the waterproof cover has been made of a material whose waterproof ability is reduced when the cover is in contact with sea water or soapy water.

However, a waterproof cover made of a material whose waterproof ability is not reduced even when the cover is in contact with sea water or soapy water does not have an air-permeability (permeability). When the non-air permeable waterproof cover is employed, there is no escape space of air in the acoustic component chamber while the acoustic component is assembled with the housing. Accordingly, the internal pressure of the acoustic component chamber may be largely increased so that, for example, a diaphragm (a vibration plate) of the acoustic component may be damaged.

The following are reference documents.

[Document 1] Japanese Laid-Open Patent Publication No. 2013-5349, and

[Document 2] Japanese Laid-Open Patent Publication No. 2013-121059.

### SUMMARY

According to an aspect of the invention, An electronic device includes: a component accommodated within a housing; a first fitting portion protruding from an inner surface of the housing toward the component; and a second fitting portion fitted to the first fitting portion, the second fitting portion including a second abutting surface abutted on a first abutting surface of the first fitting portion, wherein the component is sealed in a component chamber by a sealing member constituted by the first fitting portion and the second fitting portion, and a groove or a lateral hole is formed in the first abutting surface or the second abutting surface.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an external view of a mobile phone according to an exemplary embodiment 1;

FIG. 2 is a first exploded view illustrating a part of the mobile phone according to the exemplary embodiment 1;

FIG. 3 is a second exploded view illustrating a part of the mobile phone according to the exemplary embodiment 1;

FIG. 4 is a cross-sectional view illustrating a waterproof structure of the mobile phone according to the exemplary embodiment 1;

FIG. 5 is a first perspective view illustrating a sealing pedestal according to the exemplary embodiment 1;

FIG. 6 is a second perspective view illustrating the sealing pedestal according to the exemplary embodiment 1;

FIG. 7 is a view illustrating the mobile phone according to the exemplary embodiment 1 which is being assembled;

FIG. 8 is a view explaining a mobile phone according to a modified example 1;

FIG. 9 is a view explaining a mobile phone according to a modified example 2;

FIG. 10 is a view explaining a mobile phone according to a modified example 3;

FIG. 11 is a view explaining a mobile phone according to a modified example 4;

FIG. 12 is a view explaining a mobile phone according to a modified example 5;

FIG. 13 is a view explaining a mobile phone according to a modified example 6; and

FIG. 14 is a view explaining a mobile phone according to a modified example 7.

### DESCRIPTION OF EMBODIMENTS

Hereinafter, descriptions will be made on an electronic device and an assembly method thereof according to an exemplary embodiment of the present disclosure with reference to drawings.

### Exemplary Embodiment 1

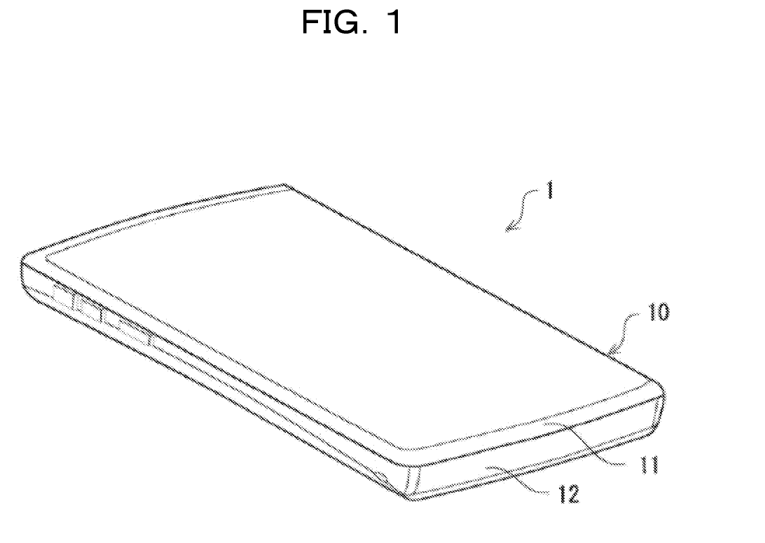

FIG. 1 is an external view of a mobile phone 1 as an electronic device according to an exemplary embodiment 1. The mobile phone 1 includes a housing 10, and various components are embedded within the housing 10.

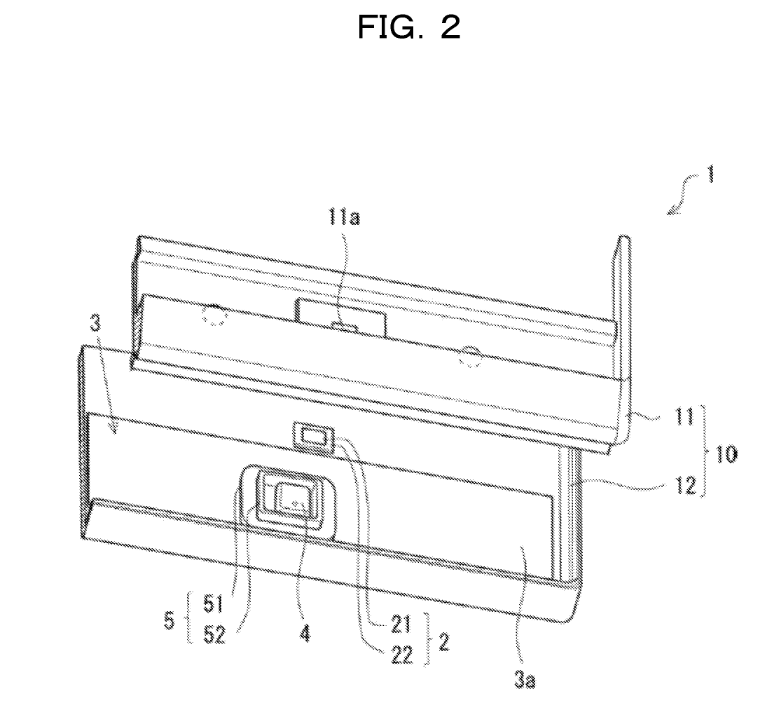

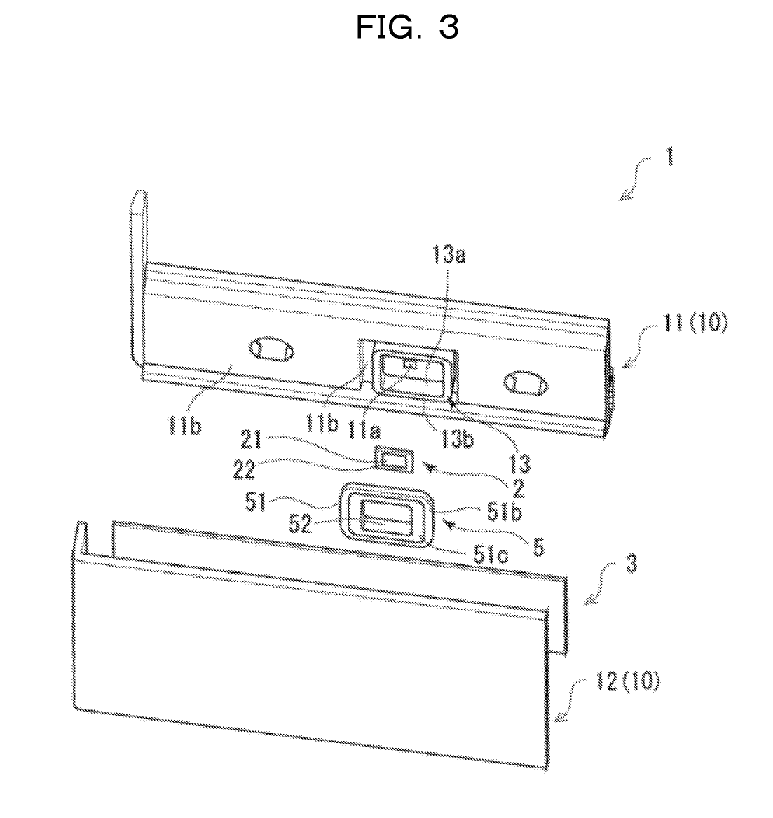

FIGS. 2 and 3 illustrate a front housing 11 and a rear housing 12 which are parts of the housing 10. The front housing 11 and the rear housing 12 may be manufactured by molding, for example, a synthetic resin such as polycarbonate or ABS resin. The front housing 11 and the rear housing 12 are connected to each other through a water stop packing (not illustrated) sandwiched between the front housing 11 and the rear housing 12.

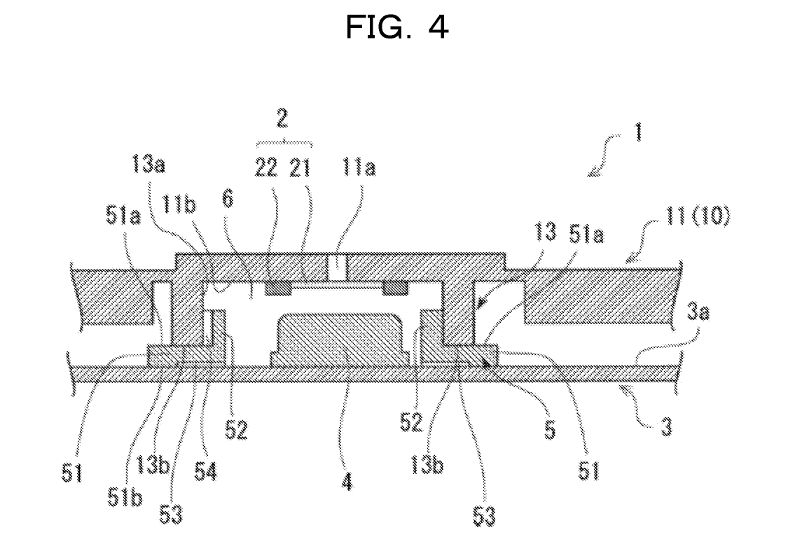

FIG. 4 is a cross-sectional view explaining a waterproof structure of the mobile phone 1 according to the exemplary embodiment, which illustrates a part of a cross-sectional view passing through an air vent groove 54 of a sealing pedestal 5 to be described later. A microphone sound hole 11a is provided in the longitudinal direction of the front housing 11 to be used for a call function. The microphone sound hole 11a is formed through the front housing 11, and communicates with the inner space of the housing 10, that is, a space for accommodating various components, and the outside of the housing 10.

For example, a protective cover member 2, a control board 3, a microphone 4, and the sealing pedestal 5 are accommodated within the housing 10. The microphone 4 is an acoustic component configured to convert sound into an electrical signal, and converts the sound obtained through the microphone sound hole 11a into the electrical signal. The microphone 4 is mounted on the control board 3, and is electrically connected to the control board 3. The microphone 4 is an example of a non-water resistant component. FIGS. 2 and 3 illustrate a part of the front housing 11, the rear housing 12 and the control board 3. The various components may be acoustic components having a diaphragm (a vibration plate) which may be damaged during assembly, and may include, for example, a speaker besides the microphone.

The control board 3 is disposed along a planar direction of the front housing 11 and the rear housing 12, and the microphone 4 is mounted on the control board 3 to face the microphone sound hole 11a formed in the front housing 11. Hereinafter, a surface of the control board 3 mounted with the microphone 4 is called “a mounting surface 3a.” The microphone 4 includes a vibration plate (not illustrated) for receiving sound, and the vibration plate is disposed to face the microphone sound hole 11a formed in the front housing 11. The microphone 4 is configured to detect a displacement of the vibration plate which vibrates by a sound pressure of the sound entering the inside of the housing from the microphone sound hole 11a. Then, the microphone 4 converts the received sound into an electrical signal.

In the mobile phone 1, the protective cover member 2 is arranged within the housing 10 to suppress water and dust from intruding into the housing 10 from the microphone sound hole 11a. The protective cover member 2 includes a waterproof film 21 and a holding portion 22 configured to hold the waterproof film 21. The holding portion 22 has a substantially rectangular parallelepiped shape, and is made of, for example, a compressible material such as polyurethane foam.

A through hole is formed through the holding portion 22 in the thickness direction, and the waterproof film 21 is provided to close the through hole. The waterproof film 21 is a waterproof sheet having a non-air permeability and a sound transmittance. That is, the waterproof film 21 has a sound permeability, but does not have an air-permeability (permeability). The waterproof film 21 may be made of, for example, polyethylene terephthalate (PET), Polyethylene (PE), or polypropylene (PP). The protective cover member 2 is provided to a location corresponding to the microphone sound hole 11a so that the waterproof film 21 covers the microphone sound hole 11a. In this manner, when the waterproof film 21 is disposed to overlap the microphone sound hole 11a of the front housing 11, water or dust may be suppressed from intruding into the housing 10 from the microphone sound hole 11a.

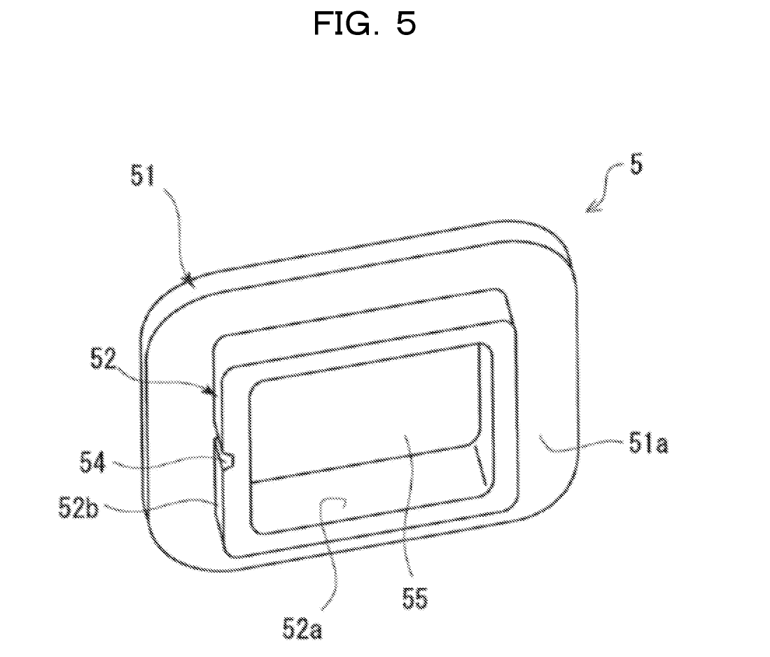

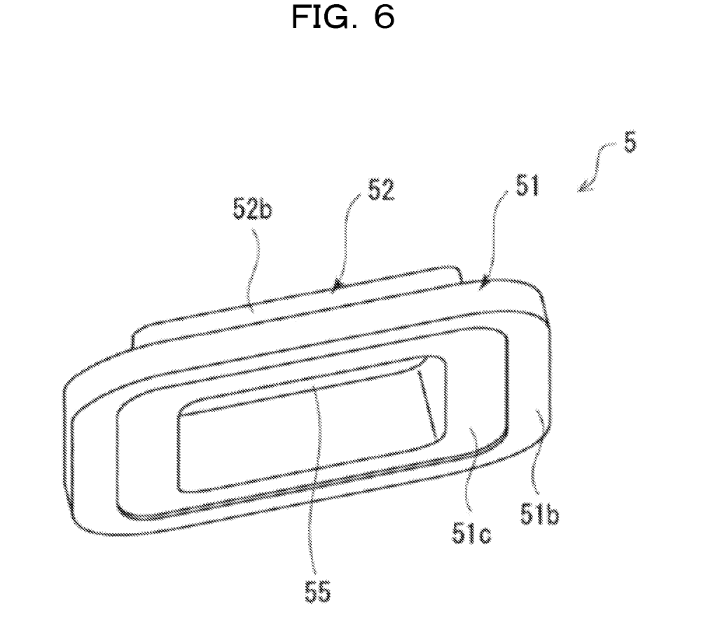

In the present exemplary embodiment, the waterproof film 21 of the protective cover member 2 does not have an air-permeability, and thus its weight may be greater than that of a waterproof film having an air-permeability. The large weight of the waterproof film 21 may reduce the sensitivity of the microphone 4. Thus, it is desirable to increase the sound insulation of the microphone chamber 6 which faces at least a part of the microphone 4 within the housing 10. Therefore, in the present exemplary embodiment, the sealing pedestal 5 is interposed between the control board 3 and an inner surface 11b of the front housing 11. FIGS. 5 and 6 are perspective views illustrating the sealing pedestal 5 according to the exemplary embodiment 1. The microphone chamber 6 is an example of a component chamber. In the present exemplary embodiment, the microphone 4 is accommodated in the microphone chamber 6.

The sealing pedestal 5 is an example of a sealing member configured to isolate (shield) the microphone chamber 6 from another space within the housing 10 and seal the microphone chamber 6. The sealing pedestal 5 is made of a compressible material such as rubber or polyurethane foam, and includes a base 51 and a fitting portion 52. In the sealing pedestal 5, the base 51 and the fitting portion 52 are integrally molded.

The base 51 of the sealing pedestal 5 is fixed to the mounting surface 3a of the control board 3 through, for example, an adhesive tape, and has a substantially square planar shape. Reference numeral 51a indicates a top surface of the base 51, and reference numeral 51b indicates a bottom surface of the base 51. A through hole is formed through the base 51 in the thickness direction. Further, the inner portion of the bottom surface 51b of the base 51, except the outer periphery of the bottom surface 51b, is recessed by one step so that a recess 51c is formed in the bottom surface 51b. When the base 51 of the sealing pedestal 5 is fixed to the mounting surface 3a of the control board 3, a two-sided tape 53 may be disposed in the recess 51c of the bottom surface 51b to suppress a step from occurring between the two-sided tape 53 and the outer periphery of the bottom surface 51b. Accordingly, the sealing pedestal 5 may be fixed to the control board 3 in a state where the bottom surface 51b of the base 51 is in close contact with the mounting surface 3a of the control board 3. The two-sided tape 53 is formed into an annular shape in plan view so as not to block the through hole of the base 51.

The fitting portion 52 of the sealing pedestal 5 is an annular peripheral wall in plan view which is provided to be erected upwards from the top surface 51a of the base 51. In the example illustrated in FIG. 5, the fitting portion 52 has a substantially square shape in plan view. An inner peripheral surface 52a of the fitting portion 52 continuously extends from the inner peripheral surface of the base 51. An air vent groove 54 is formed in an outer peripheral surface 52b of the fitting portion 52 along the height direction of the fitting portion 52.

In the present exemplary embodiment, the air vent groove 54 is formed over the entire section from the upper end (the distal end) of the fitting portion 52 to the lower end (the proximal end). The lower end (the proximal end) of the fitting portion 52 is an end portion to be coupled to the top surface 51a of the base 51. In the sealing pedestal 5 formed as described above, a hollow portion 55 is formed at the inner periphery side of the fitting portion 52 and the base 51. The microphone 4 mounted on the control board 3 is disposed in the hollow portion 55, as illustrated in FIG. 4.

As illustrated in FIGS. 3 and 4, a fitted portion 13 is provided on the inner surface 11b of the front housing 11 in the housing 10 to protrude from the inner surface 11b to the control board 3 and the microphone 4. The fitted portion 13 is a wall member formed in an annular shape in plan view. An inner peripheral surface 13a of the fitted portion 13 is formed in a shape similar to that of the outer peripheral surface 52b of the fitting portion 52 in the sealing pedestal 5, and is designed to be slightly smaller than the outer peripheral surface 52b.

In the present exemplary embodiment, when the mobile phone 1 is assembled, the fitting portion 52 in the sealing pedestal 5 is fitted to the fitted portion 13 formed on the inner surface 11b of the front housing 11. As a result, the outer peripheral surface 52b of the fitting portion 52 and the inner peripheral surface 13a of the fitted portion 13 abut on each other. Accordingly, the microphone chamber 6 is isolated from another space within the housing 10 to seal the microphone 4. The outer peripheral surface 52b of the fitting portion 52 is an example of an abutting surface, and the inner peripheral surface 13a of the fitted portion 13 is an example of an abutted surface.

FIG. 4 illustrates the mobile phone 1 which is completely assembled, in which the microphone 4 is sealed. When the mobile phone 1 is assembled, the front housing 11 and the control board 3 are fastened to each other by a fastening member such as a fixing screw (not illustrated). Here, a mutual position of the fitted portion 13 of the front housing 11 side and the fitting portion 52 of the sealing pedestal 5 side is adjusted so that the positions of the fitted portion 13 and the fitting portion 52 coincide with each other in plain view.

When a fixing screw is fastened to fix the control board 3 attached with the microphone 4 and the sealing pedestal 5 to the front housing 11, a compressive force is acted on the sealing pedestal 5. For example, when the fixing screw is fastened according to a specification and the sealing pedestal 5 is pressurized in the thickness direction by a specified amount, the sealing property (airtightness) of the microphone chamber 6 is ensured. However, when the mobile phone 1 is assembled, the sealing pedestal 5 is compressed, thereby reducing the volume of the microphone chamber 6.

In the mobile phone 1 in the present exemplary embodiment, since the waterproof film 21 which covers the microphone sound hole 11a does not have an air-permeability, the air (pressure) of the microphone chamber 6 may not escape to the outside through the waterproof film 21. Here, when the internal pressure of the microphone chamber 6 is excessively increased during the assembly of the mobile phone 1, the vibration plate of the microphone 4 may be damaged. Therefore, the mobile phone 1 employs a structure in which the air vent groove 54 described above is formed in the sealing pedestal 5 so that the air (pressure) of the microphone chamber 6 may escape to the outside of the microphone chamber 6 through the air vent groove 54 during the assembly of the mobile phone 1.

In compression of the sealing pedestal 5, when the compression rate is set to be excessively high, the repulsive force of the sealing pedestal 5 may be increased, thereby making the sealing degree of the housing 10 incomplete. Therefore, in the sealing pedestal 5 of the present exemplary embodiment, a location of the air vent groove 54 is provided in the fitting portion 52 instead of the base 51.

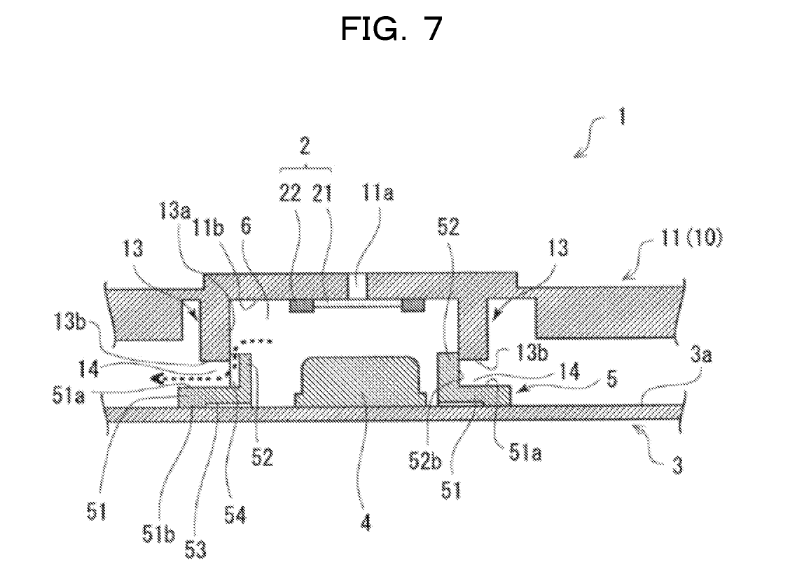

FIG. 7 is a view illustrating the mobile phone 1 which is being assembled. FIG. 7 illustrates a part of a cross-section passing through the air vent groove 54 of the sealing pedestal 5 in the mobile phone 1. When the mobile phone 1 is assembled, the fitting portion 52 of the sealing pedestal 5 is fitted to the fitted portion 13 protruding from the inner surface 11b of the front housing 11, as described above.

Since the inner peripheral surface 13a of the fitted portion 13 is designed to be slightly smaller than the outer peripheral surface 52b of the fitting portion 52 in the sealing pedestal 5, the inner peripheral surface 13a of the fitted portion 13 and the outer peripheral surface 52b of the fitting portion 52 come in contact with each other in a sliding manner and are fitted to each other.

In the state illustrated in FIG. 7, the top surface 51a of the base 51 in the sealing pedestal 5 is isolated from a distal end surface 13b of the fitted portion 13 in the front housing 11, and an air vent gap 14 is formed between the top surface 51a and the distal end surface 13b. Accordingly, in that state, the microphone chamber 6 (the hollow portion 55) is communicated with the outside through the air vent groove 54 formed in the fitting portion 52 of the sealing pedestal 5 and the air vent gap 14. Accordingly, during an assembly process of the mobile phone 1, the microphone 4 may be assembled with the housing 10 while the air of the microphone chamber 6 is purged from the air vent groove 54 (i.e., the pressure is released).

The dashed arrow in FIG. 7 conceptually illustrates the flow of air which is released from the inside of the microphone chamber 6 to the outside while the fitting portion 52 of the sealing pedestal 5 is fitted to the fitted portion 13 of the front housing 11. As described above, according to the assembly method of the mobile phone 1 according to the present exemplary embodiment, it is possible to suppress the pressure within the microphone chamber 6 from increasing when the microphone 4 is assembled.

As a result, the vibration plate of the microphone 4 may be suppressed from being damaged. When the pressure within the microphone chamber 6 is suppressed from being increased during the assembly of the microphone 4, a constant displacement may be suppressed from being provided to the vibration plate of the microphone 4. Accordingly, the manufacturing variations of the microphone 4 may be reduced.

Meanwhile, while the fitting portion 52 is gradually fitted to the fitted portion 13, the width of the air vent gap 14 is gradually decreased. At a point of time the distal end surface 13b of the fitted portion 13 is abutted on the top surface 51a of the base 51 in the sealing pedestal 5, the width of the air vent gap 14 becomes 0, and the air vent groove 54 is not communicated with the outside of the microphone chamber 6. Accordingly, as illustrated in FIG. 4, the communication state between the inside and outside of the microphone chamber 6 through the air vent groove 54 is interrupted.

Here, when the fixing screw is fastened to a predetermined position to fix the control board 3 to the front housing 11, the predetermined fastening amount of the fixing screw is set such that the distal end surface 13b of the fitted portion 13 is abutted on the top surface 51a of the base 51, and the fitting portion 52 is compressed slightly in the thickness (height) direction. As a result, while the fitting portion 52 of the sealing pedestal 5 is fitted to the fitted portion 13 of the front housing 11, the air is suppressed from escaping from the microphone chamber 6 through the air vent groove 54 and the air vent gap 14. Accordingly, when the assembly of the microphone 4 is completed, the microphone chamber 6 may be placed in a sealed state so as to satisfactorily ensure a sound insulation of the microphone chamber 6. As a result, the sensitivity of the microphone 4 may be improved.

Here, in the sealing pedestal 5 of the present exemplary embodiment, the top surface 51a of the base 51 is a smooth surface. Also, the distal end surface 13b of the fitted portion 13 protruding from the inner surface 11b of the front housing 11 is also a smooth surface. Accordingly, when the fitting portion 52 of the sealing pedestal 5 is fitted to the fitted portion 13, the distal end surface 13b of the fitted portion 13 and the top surface 51a of the base 51 may be parallel to each other and both surfaces may be brought into contact with each other.

As a result, the distal end surface 13b of the fitted portion 13, in its entirety, may uniformly come in contact with the top surface 51a of the base 51 in the sealing pedestal 5. Accordingly, when the microphone 4 is completely assembled with the front housing 11, the airtightness of the microphone chamber 6 is ensured. Since the fitting portion 52 of the sealing pedestal 5 and the fitted portion 13 protruding from the inner surface 11b of the front housing 11 are annularly formed, the airtightness of the microphone chamber 6 may be easily ensured when the assembly of the microphone 4 is completed.

According to the present exemplary embodiment, when the fitting portion 52 of the sealing pedestal 5 is fitted to the fitted portion 13 provided in the front housing 11, the distal end surface 13b of the fitted portion 13 comes in close contact with the base 51 of the sealing pedestal 5, thereby ensuring the airtightness of the microphone chamber 6. That is, even when the base 51 of the sealing pedestal 5 is not excessively compressed, the airtightness of the microphone chamber 6 may be ensured. Therefore, it is possible to suppress the repulsive force caused by the compression of the sealing pedestal 5 from excessively increasing, where the repulsive force is acting in a direction in which the control board 3 is separated from the inner surface 11b of the front housing 11.

Accordingly, when the mobile phone 1 is assembled, the sealing of the housing 10 may be suppressed from being incomplete. In a state where the fitting portion 52 of the sealing pedestal 5 is fitted to the fitted portion 13, the outer peripheral surface 52b of the fitting portion 52 pressurizes the inner peripheral surface 13a of the fitted portion 13. In this manner, when the outer peripheral surface 52b of the fitting portion 52 and the inner peripheral surface 13a of the fitted portion 13 come in close contact with each other, the sealing property and the sound insulation of the microphone chamber 6 may be improved. Since the fitting portion 52 is fitted to the fitted portion 13, the sealing property of the microphone chamber 6 may be suitably ensured due to a horizontal stress acting between the fitting portion 52 and the fitted portion 13.

As described above, according to the mobile phone 1 in the present exemplary embodiment, the microphone 4 may be assembled with the housing 10 while allowing the air to escape from the microphone 4. Thus, the damage to the microphone 4 may be suitably suppressed. Also, when the microphone 4 is assembled, communication between the inside and the outside of the microphone chamber 6 is interrupted. Thus, the airtightness of the microphone chamber 6 may be ensured so that the mobile phone 1 having the microphone 4 with an increased sensitivity state may be provided to a user. Further, a plurality of air vent grooves 54 may be provided in the fitting portion 52.

### Modified Example

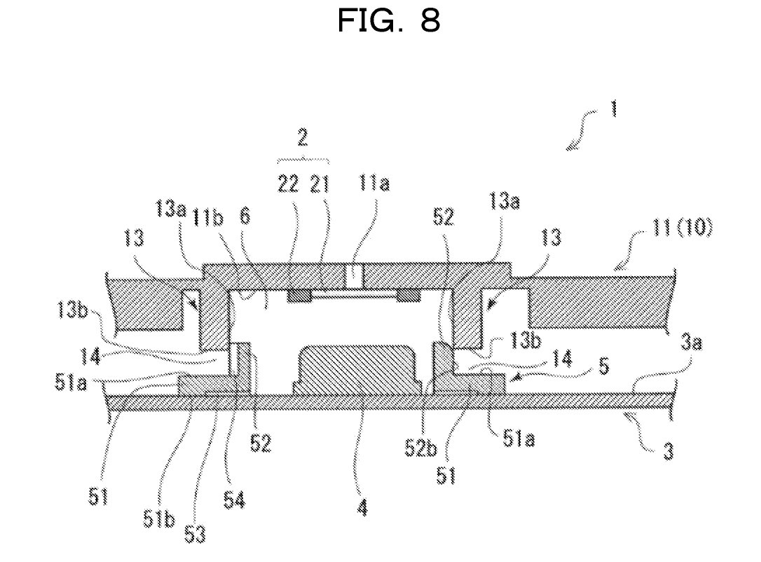

Modified examples of the mobile phone 1 will be described. FIG. 8 is a view explaining the mobile phone 1 according to a modified example 1. For example, in the sealing pedestal 5 illustrated in FIG. 8, the top end of the outer peripheral surface 52b in the fitting portion 52 is formed into a round shape (an R shape). In this manner, the fitting portion 52 of the sealing pedestal 5 may be easily fitted to the fitted portion 13 of the front housing 11. That is, the fitting easiness of the fitting portion 52 in the sealing pedestal 5 may be improved. The top end of the outer peripheral surface 52b in the fitting portion 52 may be obliquely cut into a chamfered shape. In this case, the same effect as that in the case where the top end is formed into the round shape may be achieved.

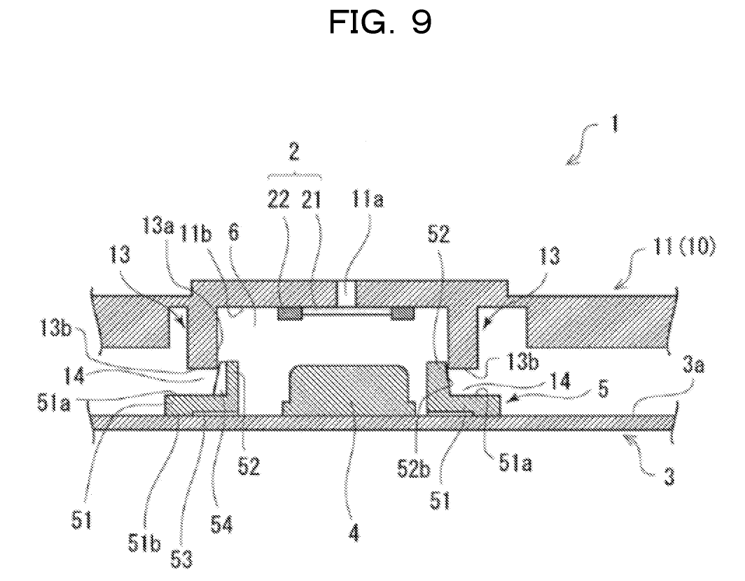

FIG. 9 is a view explaining the mobile phone 1 according to a modified example 2. As illustrated in FIG. 9, the outer peripheral surface 52b of the fitting portion 52 of the sealing pedestal 5 may be formed into a tapered shape such that its distal end portion becomes thinner from the bottom side to the top side. Accordingly, the fitting easiness of the fitting portion 52 with respect to the fitted portion 13 may be improved.

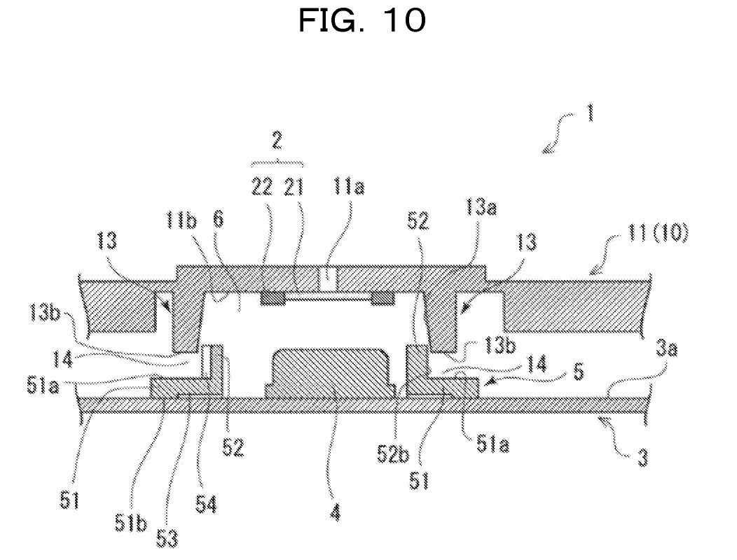

FIG. 10 is a view explaining the mobile phone 1 according to a modified example 3. As illustrated in FIG. 10, the fitted portion 13 protruding from the front housing 11 may be formed into a reversed-tapered shape such that its lower side is gradually broaden from the proximal end to the distal end. Accordingly, the fitting portion 52 of the sealing pedestal 5 may be easily fitted to the fitted portion 13. Each of FIGS. 8 to 10 as described above corresponds to FIG. 7, and illustrates the mobile phone 1 which is being assembled. That is, the drawings illustrate the mobile phone 1 during the process of fitting the fitting portion 52 of the sealing pedestal 5 fixed to the control board 3 mounted with the microphone 4, to the fitted portion 13 of the front housing 11. Each of FIGS. 8 to 10 illustrates, as in FIG. 7, a part of a cross-section passing through the air vent groove 54 of the sealing pedestal 5 in the mobile phone 1.

In the exemplary embodiment 1, the air vent groove 54 is formed on the outer peripheral surface 52b of the fitting portion 52 in the sealing pedestal 5. However, the air vent groove 54 may be formed on the inner peripheral surface 13a of the fitted portion 13 at the front housing 11 side. In this case as well, the pressure of the microphone chamber 6 may escape through the air vent groove 54 until the distal end surface 13b of the fitted portion 13 is in close contact with the top surface 51a of the base 51 in the sealing pedestal 5. In the fitted portion 13, a plurality of air vent grooves 54 may be provided.

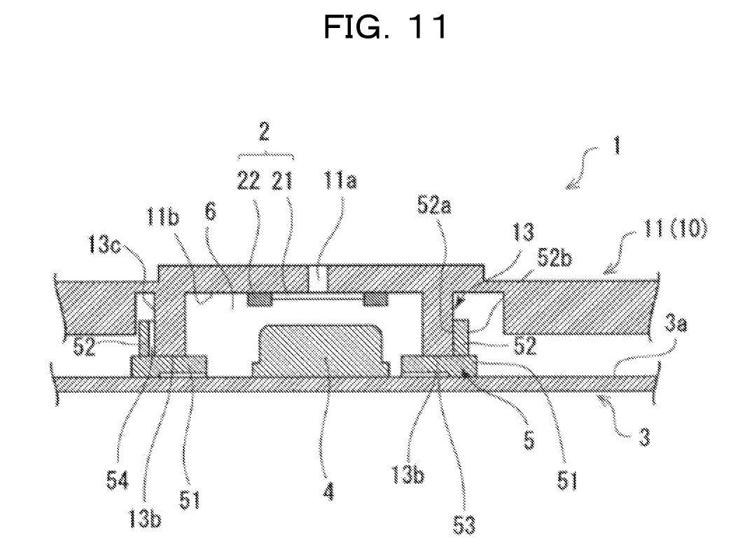

In the exemplary embodiment 1, the fitting portion 52 in the sealing pedestal 5 is internally fitted to the fitted portion 13 in the front housing 11, but the present disclosure is not limited thereto. FIG. 11 is a view explaining the mobile phone 1 according to a modified example 4. FIG. 11 illustrates a part of a cross-section passing through the air vent groove 54 in the sealing pedestal 5 in the mobile phone 1. For example, as illustrated in FIG. 11, the fitting portion 52 in the sealing pedestal 5 may be externally fitted to the fitted portion 13.

In the example illustrated in FIG. 11, the fitting portion 52 in the sealing pedestal 5 is externally fitted to the fitted portion 13 of the front housing 11, and the inner peripheral surface 52a of the fitting portion 52 is abutted on and is in close contact with an outer peripheral surface 13c of the fitted portion 13. In this case, the air vent groove 54 may be formed on the inner peripheral surface 52a of the fitting portion 52 or on the outer peripheral surface 13c of the fitted portion 13. Accordingly, the pressure of the microphone chamber 6 may escape through the air vent groove 54 until the distal end surface 13b of the fitted portion 13 is in close contact with the top surface 51a of the base 51 in the sealing pedestal 5.

In the modified example illustrated in FIG. 11, the outer peripheral surface 13c of the fitted portion 13 may be designed to be slightly larger than the inner peripheral surface 52a of the fitting portion 52 in the sealing pedestal 5. Accordingly, when the fitting portion 52 of the sealing pedestal 5 is externally fitted to the fitted portion 13, the outer peripheral surface 13c of the fitted portion 13 is fastened from the outside by the inner peripheral surface 52a of the fitting portion 52, thereby improving adhesion between them.

In the modified example 4 illustrated in FIG. 11, the inner peripheral surface 52a of the fitting portion 52 is an example of an abutting surface, and the outer peripheral surface 13c of the fitted portion 13 is an example of an abutted surface. As in the modified example 4, in a case where the fitting portion 52 of the sealing pedestal 5 is externally fitted to the fitted portion 13, the air vent groove 54 may be formed at the fitted portion 13 side as well. In such a case, the air vent groove 54 may be formed on the outer peripheral surface 13c of the fitted portion 13, the outer peripheral surface 13c being abutted on the inner peripheral surface 52a of the fitting portion 52 when the fitting portion 52 is externally fitted to the fitted portion 13. Accordingly, the pressure of the microphone chamber 6 may escape through the air vent groove 54 until the distal end surface 13b of the fitted portion 13 is in close contact with the top surface 51a of the base 51 in the sealing pedestal 5.

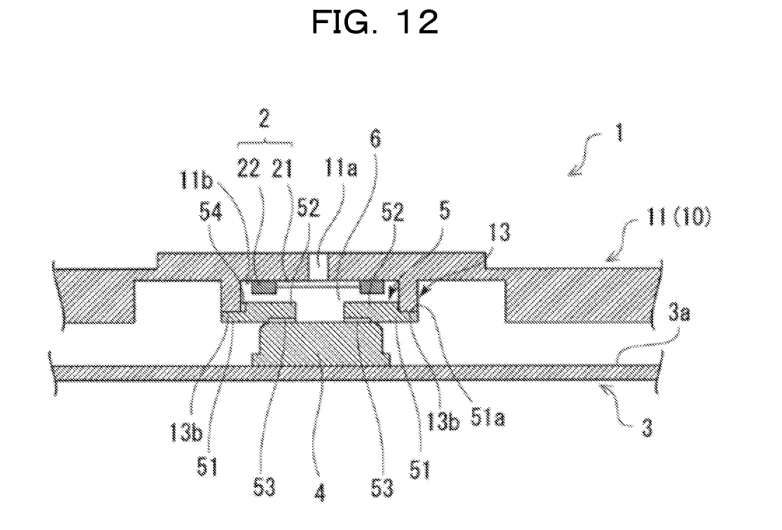

In the exemplary embodiment 1, the sealing pedestal 5 is fixed to the control board 3, but the present disclosure is not limited thereto. FIG. 12 is a view explaining the mobile phone 1 according to a modified example 5. FIG. 12 illustrates a part of a cross-section passing through the air vent groove 54 of the sealing pedestal 5 in the mobile phone 1. For example, as illustrated in FIG. 12, the sealing pedestal 5 may be directly fixed to the microphone 4.

The sealing pedestal 5 illustrated in FIG. 12 seals the microphone chamber 6 which the vibration plate of the microphone 4 faces by isolating the microphone chamber 6 from another space within the housing 10. The structure of the sealing pedestal 5 according to the present modified example is the same as that of the sealing pedestal 5 according to the exemplary embodiment 1. The sealing pedestal 5 is fitted to the fitted portion 13 provided in the front housing 11 when the microphone 4 is assembled with the front housing 11. Each of FIGS. 11 and 12 described above corresponds to FIG. 4, and illustrates a state where the mobile phone 1 is completely assembled.

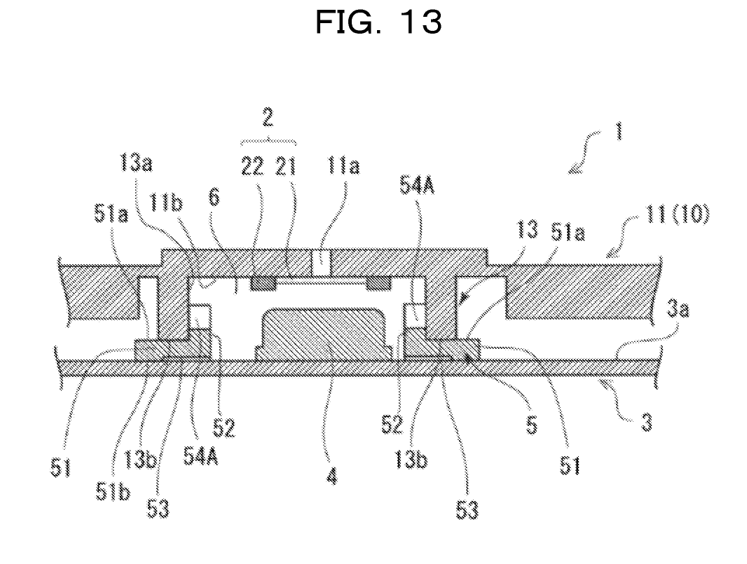

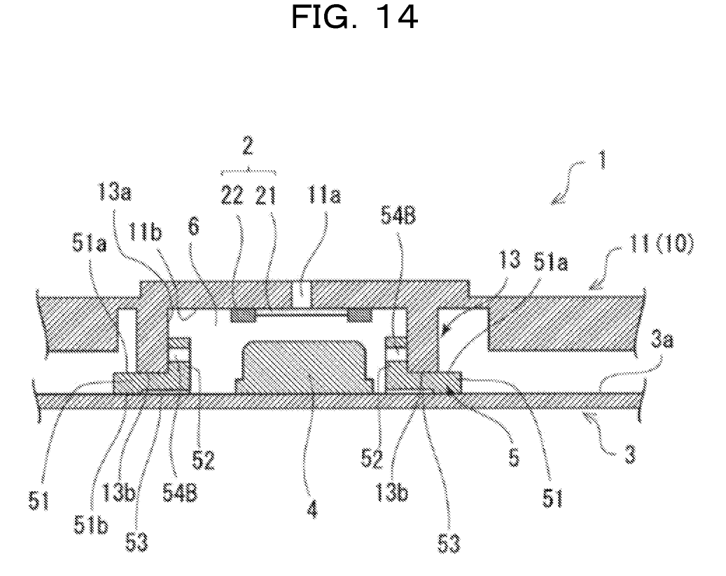

In the exemplary embodiment and modified examples as described above, the air vent groove 54 is provided in the fitting portion 52 of the sealing pedestal 5 or in the fitted portion 13. Alternatively, a (lateral) groove or a (lateral) hole which crosses the fitting portion 52 may be provided. FIG. 13 is a view explaining the mobile phone 1 according to a modified example 6. FIG. 14 is a view explaining the mobile phone 1 according to a modified example 7. Each of FIGS. 13 and 14 corresponds to FIG. 4, and illustrates a state where the mobile phone 1 is completely assembled. In the sealing pedestal 5 illustrated in FIG. 13, a lateral groove 54A crossing the fitting portion 52 is formed on the fitting portion 52.

FIG. 13 illustrates a part of a cross-section passing through the lateral groove 54A of the sealing pedestal 5 in the mobile phone 1. In the sealing pedestal 5 illustrated in FIG. 14, a lateral hole 54B crossing the fitting portion 52 is formed on the fitting portion 52. FIG. 14 illustrates a part of a cross-section passing through the lateral hole 54B of the sealing pedestal 5 in the mobile phone 1. Even when the lateral groove 54A or the lateral hole 54B is provided in the fitting portion 52 of the sealing pedestal 5 as illustrated in FIGS. 13 and 14, the same effect as in the case where the air vent groove 54 is provided may be achieved.

That is, the sealing property of the microphone chamber 6 is ensured by the fitted portion 13 (not having an air vent groove) while the sealing pedestal 5 is fitted to the fitted portion 13. More specifically, when the distal end surface 13b of the fitted portion 13 is abutted on the top surface 51a of the base 51 in the sealing pedestal 5, the communication with the inside of the microphone chamber 6 via the lateral groove 54A (FIG. 13) or the lateral hole 54B (FIG. 14) is restricted, thereby ensuring the sealing property of the microphone chamber 6. In the structure described in the examples illustrated in FIGS. 13 and 14, the fitting portion 52 in the sealing pedestal 5 is internally fitted to the fitted portion 13. However, the structure may also be applied to a case where the fitting portion 52 is externally fitted to the fitted portion 13. That is, the lateral groove 54A or the lateral hole 54B may be provided to cross the fitting portion 52 which is externally fitted to the fitted portion 13.

In the example illustrated in FIG. 13, the lateral groove 54A is provided in the fitting portion 52 of the sealing pedestal 5, but may be provided in the fitted portion 13. In the example illustrated in FIG. 14, the lateral hole 54B is provided in the fitting portion 52 of the sealing pedestal 5, but may be provided in the fitted portion 13. When the lateral groove 54A or the lateral hole 54B is provided at the fitted portion 13 side as described above, the sealing property of the microphone chamber 6 is ensured by the fitting portion 52 of the sealing pedestal 5 (which does not have the lateral groove 54A or the lateral hole 54B) while the sealing pedestal 5 is fitted to the fitted portion 13.

More specifically, when the distal end surface 13b of the fitted portion 13 is abutted on the top surface 51a of the base 51 in the sealing pedestal 5, the communication with the inside of the microphone chamber 6 via the lateral groove or hole of the fitted portion 13 is restricted, thereby ensuring the sealing property of the microphone chamber 6. The above described structure in which the lateral groove 54A or the lateral hole 54B is provided in the fitted portion 13 is not limited to the case where the fitting portion 52 of the sealing pedestal 5 is internally fitted to the fitted portion 13, but also may be applied to the case where the fitting portion 52 is externally fitted to the fitted portion 13.

The above described exemplary embodiment may be modified in various ways without departing from the scope of the present disclosure. Further, the exemplary embodiment and modified examples as described above may be implemented in combination as much as possible. For example, in the exemplary embodiment as described above, the sealing pedestal 5 is employed to seal the microphone 4, but the present disclosure is not limited thereto. For example, the sealing pedestal 5 may be used to seal the speaker as an example of an acoustic component. Also, in the exemplary embodiment as described above, the mobile phone is employed as an example of an electronic device, but the present disclosure may be applied to other electronic devices such as a notebook computer or a tablet computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a component accommodated within a housing;
a first fitting portion protruding from an inner surface of the housing toward the component; and
a second fitting portion fitted to the first fitting portion, the second fitting portion including a second abutting surface abutted on a first abutting surface of the first fitting portion,
wherein the component is sealed in a component chamber by a sealing member constituted by the first fitting portion and the second fitting portion, and a groove or a lateral hole is formed in the first abutting surface or the second abutting surface.

2. The electronic device according to claim 1, wherein
the second fitting portion includes a base in contact with a distal end surface of the first fitting portion, and
when the distal end surface is in close contact with the base, a communication state between an inside and an outside of the component chamber via the groove or the lateral hole is interrupted.

3. The electronic device according to claim 1, wherein
the component is an acoustic component, and
a sound hole formed at a position of the housing corresponding to the component is covered with a non-air permeable waterproof film provided within the housing.

4. The electronic device according to claim 1, wherein
the second fitting portion and the first fitting portion are annularly formed.

5. A method of assembling an electronic device, comprising
fitting a first fitting portion protruding to an inside of a housing to a second fitting portion provided around a component while abutting the first fitting portion on the second fitting portion; and
escaping air to an outside from a groove or a lateral hole formed in a first abutting surface of the first fitting portion or a second abutting surface of the second fitting portion.
